(19) United States
(12) Patent Application Publication
(10) Pub. No.: US 2025/0074519 A1
(43) Pub. Date: Mar. 6, 2025

(54) Ice Scratcher

(71) Applicant: Bombardier Recreational Products, Inc., Valcourt (CA)

(72) Inventors: Anthony Marineau, St-Denis-de-Brompton (CA); Jeremie-Alex Boisvert, Sherbrooke (CA); Jonathan Asselin, Magog (CA); Nicolas Gagnon, Sherbrooke (CA)

(21) Appl. No.: 18/826,053

(22) Filed: Sep. 5, 2024

Related U.S. Application Data
(60) Provisional application No. 63/579,817, filed on Aug. 31, 2023.

(51) Int. Cl. B62D 55/092

(52) U.S. Cl. CPC B62D 55/092

(57) ABSTRACT

An ice scratcher assembly, comprises a base having a first portion and a second portion, a coiled structure coupled to the first portion, the coiled structure being interconnected to a scratcher end via an arm, and a hand structure interconnected to the second portion by at least one joint having a first axis, wherein the at least one joint is configured to receive at least one rotating component that when coupled to the at least one joint provides a rotational axis that is colinear with the first axis of the at least one joint.

### RELATED APPLICATIONS

This application is a non-provisional patent application claiming the benefit of priority of U.S. Provisional Patent Application Ser. No. 63/579,817, filed on Aug. 31, 2024, the entire disclosures of which are incorporated herein by reference in its entirety.

### FIELD OF THE INVENTION

The present invention relates to ice scratchers for snowmobiles, and to snowmobiles incorporating ice scratchers.

### BACKGROUND

Devices have been developed to scratch a surface of the ice or snow to generate a spray of ice or snow when the snowmobile operates on such surfaces in order to cool and/or lubricate other snowmobile components (e.g., heat exchangers, track, slide rails, tunnel). These devices are known by many different names (e.g., snow tillers, snow lubricators or spray generators), but as discussed herein, such devices may be referred to as ice scratchers.

Ice scratchers are disclosed in U.S. Pat. Nos. 5,277,266 and 9,038,758, but the devices disclosed are limited in terms of how such devices operatively mount to various types of machines without loss of satisfactory performance.

### SUMMARY

An exemplary ice scratcher may comprise a base having a first portion and a second portion. An exemplary ice scratcher may further comprise a coiled structure coupled to the first portion such that the coiled structure is interconnected to a scratcher end via an arm. An exemplary ice scratcher may still further comprise a hand structure interconnected to the second portion by at least one joint having a first axis such that the at least one joint is configured to receive at least one rotating component that when coupled to the at least one joint provides a rotational axis that is colinear with the first axis of the at least one joint.

In addition to the previously described embodiment and/or as an alternative to any other described exemplary embodiment, an exemplary ice scratcher may further comprise a bracket for coupling to the base.

In addition to the previously described embodiment and/or as an alternative to any other described exemplary embodiment, an exemplary ice scratcher may be configured such that the at least one rotating component is a drive track wheel for a snowmobile.

In addition to the previously described embodiment and/or as an alternative to any other described exemplary embodiment, an exemplary ice scratcher may be configured such that the ice scratcher assembly is mounted to the rear suspension of a snowmobile.

In addition to the previously described embodiment and/or as an alternative to any other described exemplary embodiment, an exemplary ice scratcher may be configured such that the ice scratcher assembly is mounted to a slide rail of the rear suspension of a snowmobile.

In addition to the previously described embodiment and/or as an alternative to any other described exemplary embodiment, an exemplary ice scratcher may be configured such that the ice scratcher assembly is mounted to the slide rail via a bracket located on a surface of the slide rail opposite to that on which second portion of the base is located.

In addition to the previously described embodiment and/or as an alternative to any other described exemplary embodiment, an exemplary ice scratcher may be configured such that the mount for the ice scratcher assembly comprises a mechanical coupling of the second portion of the base, at least two surfaces of the slide rail, and a portion of the bracket.

In addition to the previously described embodiment and/or as an alternative to any other described exemplary embodiment, an exemplary ice scratcher may be configured such that the mechanical coupling is also a rotational coupling for a drive track wheel of the rear suspension of the snowmobile.

In addition to the previously described embodiment and/or as an alternative to any other described exemplary embodiment, an exemplary ice scratcher may be configured such that a third portion of the base couples to a third surface of the slide rail.

In addition to the previously described embodiment and/or as an alternative to any other described exemplary embodiment, an exemplary ice scratcher may be configured such that the hand is configured to hold the arm of the coiled structure when the arm is sufficiently bent to be placed therein.

An exemplary ice scratcher assembly for a snowmobile having a rear suspension assembly comprising at least one drive track wheel for driving a drive track may comprise a base having a first portion and a second portion. An exemplary ice scratcher assembly may further comprise a coiled structure coupled to the first portion, such that the coiled structure may be interconnected to a scratcher end via an arm. Further, an exemplary ice scratcher assembly may be configured such that the second portion of the base may be coupled to the snowmobile via an axis around which the drive track wheel rotates.

In addition to the previously described embodiment and/or as an alternative to any other described exemplary embodiment, an exemplary ice scratcher assembly may further comprise a bracket interconnected to the base to thereby couple the ice scratcher assembly to the snowmobile.

In addition to the previously described embodiment and/or as an alternative to any other described exemplary embodiment, an exemplary ice scratcher assembly may further comprise a bracket interconnected to a slide rail and the second portion of the base to thereby couple the ice scratcher assembly to the snowmobile.

In addition to the previously described embodiment and/or as an alternative to any other described exemplary embodiment, an exemplary ice scratcher assembly may further comprise a bracket interconnected to a slide rail and both the first portion and the second portion of the base to thereby couple the ice scratcher assembly to the snowmobile.

In addition to the previously described embodiment and/or as an alternative to any other described exemplary embodiment, an exemplary ice scratcher assembly may further comprise a hand disposed along the axis and interconnected to the second portion of the base.

An exemplary method of assembling an ice scratcher to a snowmobile may comprise one or more of the following steps in the following or other order: (i) mounting a base on the rear suspension assembly so that a portion of the base shares an axis with a drive track wheel configured to be coupled to the rear suspension assembly and (ii) mounting a bracket to a side of the base opposite the drive track wheel to secure the ice scratcher to the snowmobile.

The exemplary method of assembling an ice scratcher to a snowmobile may also involve a step whereby the base comprises a coil shoulder, an arm interconnected to the coil shoulder, and a scratcher end interconnected to the arm.

### DESCRIPTION OF THE DRAWINGS

FIG. 1 illustrates an exemplary left side elevation view of a snowmobile with a driver thereon in a straddling position with an exemplary ice scratcher.

FIG. 2 illustrates an exemplary view of components of an exemplary snowmobile coupled with an exemplary ice scratcher in an operating position on an exemplary slide rail.

FIG. 3 illustrates an exemplary topographic view of the exemplary ice scratcher from FIG. 2.

FIG. 4 illustrates an exemplary embodiment of an isometric view of an exemplary ice scratcher with endless track rollers removed from view to further illustrate the exemplary ice scratcher in an exemplary coupling position on an exemplary slide rail.

FIG. 5 illustrates an exemplary embodiment of an exploded view of an exemplary ice scratcher and slide rail with the endless track rollers removed from view.

FIG. 6 illustrates an exemplary cross-sectional view of an exemplary ice scratcher as coupled to an exemplary slide rail.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

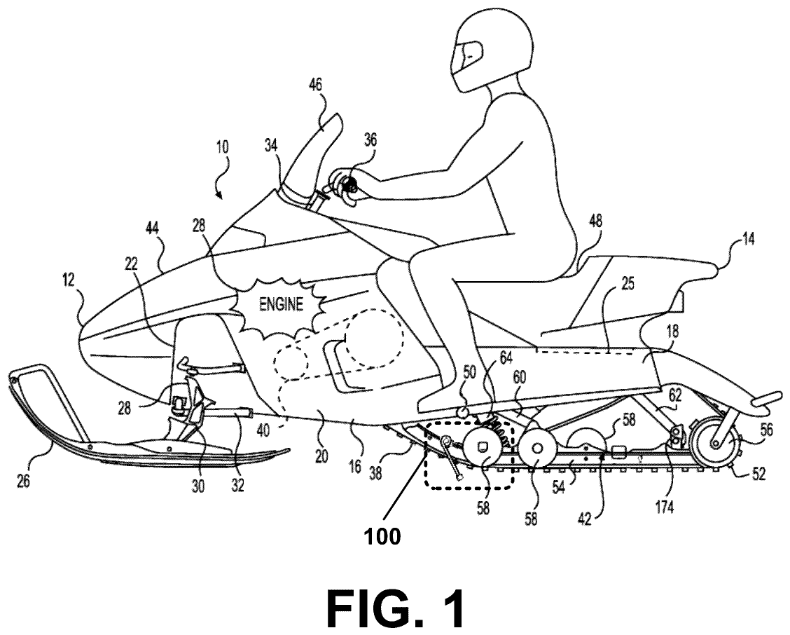

Referring to FIG. 1, a snowmobile 10 will be described. Although a snowmobile is presented herein, it is contemplated that aspects of the present invention could be applied to other types of tracked vehicles operating on snow or ice, such as all-terrain vehicles provided with track kits and snow groomers.

The snowmobile 10 includes a front end 12 and a rear end 14, which are defined consistently with the forward travel direction of the vehicle. The snowmobile 10 includes a frame 16. The frame 16 includes a tunnel 18, an engine cradle portion 20 and a front suspension assembly portion 22. An engine 24, which is schematically illustrated, is supported by the engine cradle portion 20. Coolant used to cool the engine 24 is circulated through heat exchangers 25 (schematically shown) to be cooled. The heat exchangers 25 are mounted under the tunnel 18. A ski and steering assembly is provided, in which two skis 26 (only one of which is shown) are positioned at the front end 12 of the snowmobile 10, and are attached to the front suspension assembly portion 22 through a front suspension assembly 28. The front suspension assembly 28 includes ski legs 30 and A-arms 32. It is contemplated that other types of front suspension assemblies could be used. A steering column 34 is attached at its upper end to a steering device, in this case a handlebar 36, which is positioned forward of a rider and behind the engine 24. The steering column 34 is operatively connected to the ski legs 30 and the skis 26, in order to steer the skis 36, and the snowmobile 10, when the handlebar 36 is turned. It is contemplated that the snowmobile 10 could have only one ski 26.

An endless drive track 38 is positioned at the rear end 14 of the snowmobile 10 and is disposed under the tunnel 18. The endless drive track 38 is operatively connected to the engine 24 through a belt transmission system 40 which is schematically illustrated by broken lines. Thus, the endless drive track 38 is driven to run about a rear suspension assembly 42 for propulsion of the snowmobile 10. The rear suspension assembly 42 will be described in greater detail below.

Fairings 44 are provided at the front end 12 of the snowmobile 10. The fairings 44 enclose the engine 24 and the belt transmission system 40, thereby providing an external shell that not only protects the engine 24 and the belt transmission system 40, but also make the snowmobile 10 more aesthetically pleasing. The fairings 44 include a hood and one or more side panels that can be opened to allow access to the engine 24 and the belt transmission system 40 when this is required, for inspection or maintenance of the engine 24 and/or the belt transmission system 40 for example. A windshield 46 is connected to the fairings 44 near the front end 12 of the snowmobile 10. It is contemplated that the windshield 46 could be attached directly to the handlebar 36. The windshield 46 acts as a windscreen to lessen the force of the air on the rider while the snowmobile 10 is moving forward.

A seat 48 is disposed on the tunnel 18. Two footrests 50 (only one of which is shown) are positioned on opposite sides of the tunnel 18 below the seat 48 to accommodate the rider's feet. The footrests 50 are integrally formed with the tunnel 18.

The endless drive track 38 is engaged with and driven by a drive sprocket (not shown) that is journaled by the tunnel 18 and is driven by the engine 24 through the belt transmission system 40. The endless drive track 38 is suspended for movement relative to the frame 16, by the rear suspension assembly 42, as will be described below. The endless drive track 38 has a plurality of lugs 52 extending from an outer surface thereof to provide traction to the track 38.

The rear suspension assembly 42 will now be described. The rear suspension assembly 42 includes a slide frame assembly that includes a pair of spaced apart slide rails 54 that engage the inner side of the endless drive track 38. The slide frame assembly journals a plurality of backup rollers (not shown) and four idler rollers 56 (only one being shown). Further rollers 58 are carried by the tunnel 18, in order to define the path over which the endless drive track 38 travels.

Front suspension arms 60 (only one being shown) are pivotally connected between the tunnel 18 and the slide rails 54. Rear suspension arms 62 (only one being shown) are also pivotally connected between the tunnel 18 and the slide rails 54. A front shock absorber assembly 64 is disposed between the tunnel 18 and the slide frame assembly. The front shock absorber assembly 64 is a damping unit that includes a hydraulic damper and a coil spring for absorbing the impact energy when impact forces are applied to the opposite ends of the damping unit. The coil spring biases the damping unit toward an extended position so that the hydraulic damper is in a position to absorb the impact energies. A rear shock absorber (not shown) is also provided. The above is only one possible embodiment of a rear suspension assembly that can be provided on the snowmobile 10. It is contemplated that other embodiments could be provided.

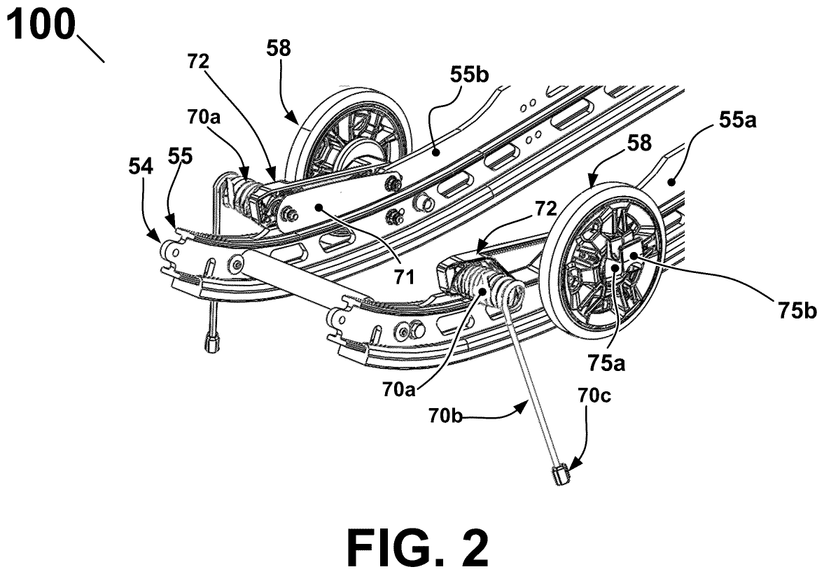

Item 100 denotes an exemplary ice scratcher assembly that may be mounted for promoting cooling to various components of snowmobile 10, such as, for example, the heat exchanger 25, the rear suspension assembly 42, the tunnel 18, etc. A more detailed view of the exemplary ice scratcher may be had with reference to FIGS. 2-6.

With reference to the illustrative embodiments described herein and illustrated in FIG. 2, an exemplary ice scratcher assembly 100 may comprise a coil shoulder 70a, a relatively resilient arm 70b, and an exemplary ice scratcher end 70c. The coil shoulder 70a may be mechanically or integrally attached to a bracket plate 71 through one or more portions of the exemplary slide rail 54. An exemplary bracket plate 71 may be adapted to hold the coil shoulder 70a to snowmobile 10 via corresponding attachment (either mechanical or integral) to a base 72. Either of bracket plate 71 or base 72 may be a machined part made of sufficiently rigid material to enable the operation of an exemplary ice scratcher assembly 100. In an exemplary embodiment, bracket 71 and base 72 may be made from one or more such techniques, such as monocoque, pseudo-moncoque, stampings, extrusions, and additive manufacturing. The coupling of ice scratcher assembly 100 to the snowmobile 10 may be achieved by the mechanical and/or integration of bracket 71 and base 72 frictional engagement with one or more surfaces 55a, 55b, and 55 of the slide rail 54.

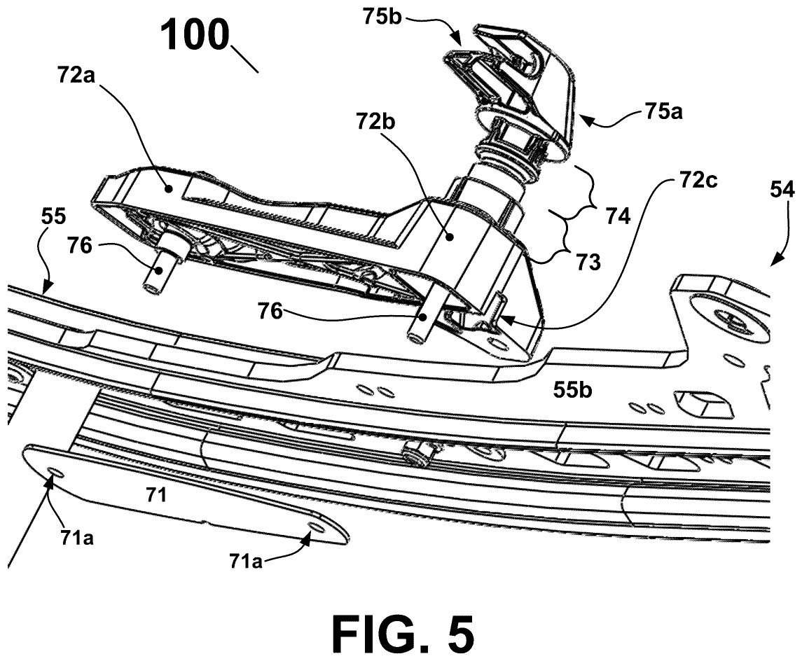

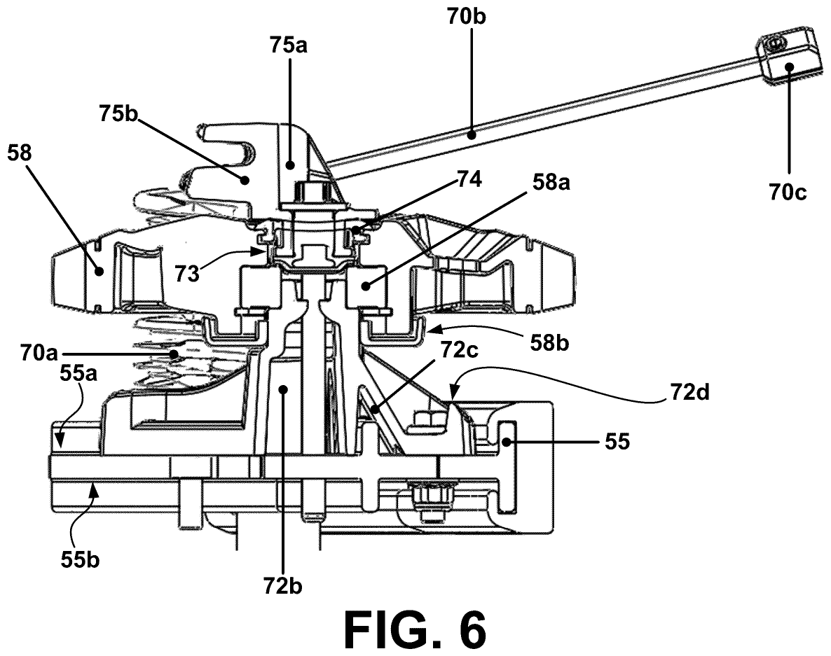

With continued reference to FIG. 2, an exemplary ice scratcher assembly 100 may comprise a base 72 having a hand 75b interconnected to base 72 via a wrist 75a and outer leg 74 and inner leg 73 (not shown, but illustrated in FIGS. 5-6). Among other improvements, an exemplary ice scratcher assembly 100 may be designed so that its base 72 overlaps with and/or otherwise joins as part of the coupling arrangement for the roller wheel 58 to operatively couple to the remainder of slide rail 54 for movement of drive track 38. Accordingly, the hand 75b may be designed to project outwardly along the axis of roller wheel 58 via wrist 75a and legs 73-74. As such, an exemplary hand 75b may be configured to hold the relatively resilient arm 70b and/or scratcher end 70c upwardly away from the surface along which the snowmobile 10 may travel. In other words, an exemplary ice scratcher assembly 100 may be configured so that the relatively resilient arm 70b may be capable of being moved into a stored position while its cross-section may be nested in hand 75b and then removed from that stored position when needed. In this way, the ice scratcher assembly 100 may be provide for a self-storage capability when not in use.

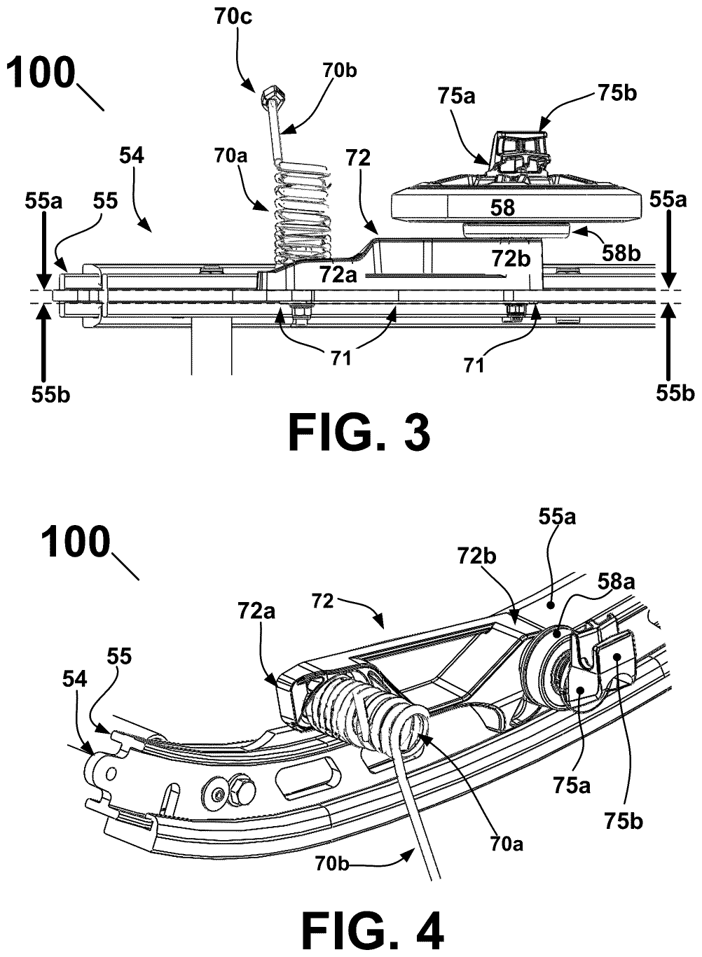

With reference to the exemplary embodiment illustrated by FIG. 3, an exemplary ice scratcher assembly 100 may be shown in a topographic view with its exemplary bracket 71 and base 72 mechanically adjoined to one another through surface 55a and 55b of slide rail 54. Further visible in FIG. 3 may be an exemplary rotational bracket 58b that may work cooperatively with other couplers, such as coupler 58a (not shown in FIG. 3, but visible in FIGS. 4 and 6), to allow for operation of roller 58 as part of snowmobile 10.

With reference to a further illustrative view of an exemplary ice scratcher assembly 100 as depicted in FIG. 4, an exemplary ice scratcher assembly 100 may be shown in an isometric view with roller wheel 58 removed from view to expose rotational coupler 58a, which may be, for example, a roller bearing or other like construct known to those skilled in the art. As illustrated, base 72 may be shown with two sections 72a and 72b to delineate between those structures/surfaces of base 72 that may be configured to couple coil shoulder 70a and those structures/surfaces of base 72 that may be configured to couple hand 75b, respectively. As shown, an exemplary base portion 72b may be a support point for the axel for the roller wheel 58 (not shown) and the wrist 75a and hand 75b coupled along the rotational axis thereof. As may also be appreciated, portions of slide rail 54 may not be in contact with one or more of coil shoulder 70a and/or base portion 70a, such as the upper T-shaped cross-sectional surface 55 of slide rail 54, but may be foundational or coupling surfaces for hand 75b and/or base portion 70b. An exemplary embodiment of alternative coupling may be had with reference to FIGS. 5-6.

As may be illustrated with FIG. 5, an exemplary base 72 may have a portion 72b that also comprises a coupling portion 72c facing the surface 55a of slide rail 54. In an exemplary embodiment, coupling portion 72c may be configured to slip or otherwise engage a part of the T-shaped surface 55 of slide rail 54 and provide yet another stability point for the ice scratcher assembly 100 vis-à-vis the rear suspension assembly 42 of snowmobile 10. As may be further illustrated, outer leg 74 and inner leg 73 may be shown without any of the rotational couplings necessary for roller wheel 58 to be operative with respect to the rear suspension assembly 42, although those skilled in the art may combine these rotational couplings into the outer leg 74 and/or inner leg 73 as may be needed to reduce parts. In any event, the mechanical couplings 76 and 71a of the base 72 and bracket 71, respectively, may be shown in exploded view with slide rail 54 located therebetween. In an exemplary embodiment, couplings 76 at a portion 72a of base 70 may frictionally or otherwise clamp the ice scratcher assembly 100 to surface 55a and 55b of slide rail 54 without passing through openings in the latter enroute to coupling with openings 71a in bracket 71. In an exemplary embodiment, couplings 76 at a portion 72b of base 70 may frictionally or otherwise clamp the ice scratcher assembly 100 to surface 55a and 55b of slide rail 54 by passing through one or more surfaces 55a and/or 55b of the slide rail 54. In an alternative embodiment each base 72 portion 72a and/or 72b may pass through or otherwise engage with one or more surfaces 55, 55a, and/or 55b of slide rail 54 to enable an exemplary slide rail assembly 100 to operatively function with snowmobile 10. In yet another alternative embodiment, each base 72 portion 72a, 72b, and/or 72c may pass through or otherwise engage with one or more surfaces 55, 55a, and/or 55b of slide rail 54 to enable an exemplary slide rail assembly 100 to operatively function with snowmobile 10. In still a further alternative embodiment, at least one base 72 portion 72a, 72b, and/or 72c may pass through or otherwise engage with one or more surfaces 55, 55a, and/or 55b of slide rail 54 to enable an exemplary slide rail assembly 100 to operatively function with snowmobile 10. In yet a still further alternative embodiment, only one base 72 portion 72a, 72b, and/or 72c may pass through or otherwise engage with one or more surfaces 55, 55a, and/or 55b of slide rail 54 to enable an exemplary slide rail assembly 100 to operatively function with snowmobile 10. By modifying the material and/or dimensions and/or surface features of an exemplary base 72 and/or bracket 71, a skilled person may enable numerous permutations of mounting an exemplary ice scratcher assembly 100 to a snowmobile 10 with the objective of a portion of the assembly 100 doubling as an operational mounting point for at least one roller wheel 58 of the rear suspension assembly 42.

With reference to the illustrative embodiment of depicted in FIG. 6, an exemplary cross-sectional view of the portion 72b of bracket 72 may be shown with an exemplary roller wheel 58 operatively coupled thereto and to slide rail 54 surfaces 55a, 55b, and 55. As may be understood with reference to FIG. 6, an exemplary ice scratcher assembly 100 may allow for hand 75b to be coupled through the rotational axis of roller wheel 58 using wrist 75a. As may be seen with respect to wrist 75a, an exemplary bolt is recessed in wrist 75a and may be used to securely anchor roller wheel 58 to the rear suspension assembly 42 and allow for easy maintenance and/or removal of the same. Further, the axis of rotation for roller wheel 58 may be shared with the axis for the rotational couplings 58a and 58b as well as with inner leg 73 and outer leg 74 of the ice scratcher assembly 100. As may be further illustrated is yet another bracket 72 portion 72d that may independently couple through surfaces 55a and/or 55b, but which may neither house a coupling for the coil shoulder 70a, the hand 75b, or the roller wheel 58. In other words, portion 72d of base 72 may act as an additional mount to increase the coupling engagement between the ice scratcher assembly 100 and the rest of slide rail 54, and as such, may enable brackets 71 and/or bases 72 with smaller profiles, lesser material, and more versatility than if absent. As may also be appreciated from the cross-section of FIG. 6 may be the relatively simple nature of the base 72 to be extruded or otherwise stamped into a configuration. Further, an appropriately shaped base 72 and its portions 72a, 72b, 72c, and/or 72d may be configured to fit numerous types of slide rails 52, rear suspension assemblies 42, roller wheels 58, and/or combinations of any of the foregoing so that an ice scratcher assembly 100 made thereby could be suited to be used on various types or kinds of snowmobile 10.

To the extent a mechanical or other integral attachment may not be depicted (e.g., coil shoulder 70a to base 72), those skilled in the art would be familiar with numerous methods of coupling the coil 70a to the remainder of base 72 either by bolts, welding, other forms of fasteners or bending the coil 70a so that it is relatively non-removably affixed to base 72. Further, while scratcher end 70c may be shown as a prismatic structure and may be formed from appropriate materials, those skilled in the art would contemplate numerous other polyhedral surfaces may be utilized for such operations of an exemplary ice scratcher assembly 100, such as, for example, cupped-shapes, spheres, tetrahedron, pyramidal, diamond, and rhomboid shapes and designs. In an exemplary embodiment, scratcher end 70c may be shaped in such a way to induce ice impacting one surface to be directed to desired surfaces one the snowmobile, e.g., a heat exchanger 25 or one or more parts of the rear suspension assembly 42. Furthermore, while wrist 75a and hand 75b may be shown as separate components, their integration is contemplated as well in these disclosures as may be any other parts of the ice scratcher assembly 100 (e.g., an integrated inner leg 73, outer leg 74, and wrist 75a, which may receive a hand 75b to close off the axis of rotation for an exemplary wheel 58 rotationally coupled thereto.

While the embodiments illustrated and described may refer to a drive track wheel 58 located closer to the terrain over which an exemplary snowmobile 10 may travel, it may be contemplated that such ice scratcher assemblies 100 may be configured to fit along any properly situated drive track wheels 58 or other parts of the rear suspension assembly 42 thereof provided coil shoulder 70a, arm 70b, and scratcher end 70c are appropriately configured to accomplish the functions and provide one or more of the benefits described. Further, an exemplary ice scratcher assembly 100 may be coupled to any other clamp-able portions of an exemplary snowmobile 10, such as, for example, foot rests, the tunnel 18, snow flaps, or other parts of the vehicle provided there may be a secure mounting for the ice scratcher assembly 100.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. An ice scratcher assembly, comprising:
a base having a first portion and a second portion;
a coiled structure coupled to the first portion, the coiled structure being interconnected to a scratcher end via an arm; and
a hand structure interconnected to the second portion by at least one joint having a first axis, wherein the at least one joint is configured to receive at least one rotating component that when coupled to the at least one joint provides a rotational axis that is colinear with the first axis of the at least one joint.

2. The ice scratcher assembly of claim 1, further comprising a bracket for coupling to the base.

3. The ice scratcher assembly of claim 1, wherein the at least one rotating component is a drive track wheel for a snowmobile.

4. The ice scratcher assembly of claim 1, wherein the ice scratcher assembly is mounted to the rear suspension of a snowmobile.

5. The ice scratcher assembly of claim 4, wherein the ice scratcher assembly is mounted to a slide rail of the rear suspension of a snowmobile.

6. The ice scratcher assembly of claim 5, wherein the ice scratcher assembly is mounted to the slide rail via a bracket located on a surface of the slide rail opposite to that on which second portion of the base is located.

7. The ice scratcher assembly of claim 6, wherein the mount for the ice scratcher assembly comprises a mechanical coupling of the second portion of the base, at least two surfaces of the slide rail, and a portion of the bracket.

8. The ice scratcher assembly of claim 7, wherein the mechanical coupling is also a rotational coupling for a drive track wheel of the rear suspension of the snowmobile.

9. The ice scratcher assembly of claim 8, wherein a third portion of the base couples to a third surface of the slide rail.

10. The ice scratcher assembly of claim 1, wherein the hand is configured to hold the arm of the coiled structure when the arm is sufficiently bent to be placed therein.

11. An ice scratcher assembly for a snowmobile having a rear suspension assembly comprising at least one drive track wheel for driving a drive track, comprising:
a base having a first portion and a second portion; and
a coiled structure coupled to the first portion, the coiled structure being interconnected to a scratcher end via an arm, wherein
the second portion of the base is configured to be coupled to the snowmobile via an axis around which the drive track wheel rotates.

12. The ice scratcher assembly of claim 11, further comprising a bracket interconnected to the base to thereby couple the ice scratcher assembly to the snowmobile.

13. The ice scratcher assembly of claim 12, further comprising a bracket interconnected to a slide rail and the second portion of the base to thereby couple the ice scratcher assembly to the snowmobile.

14. The ice scratcher assembly of claim 12, further comprising a bracket interconnected to a slide rail and both the first portion and the second portion of the base to thereby couple the ice scratcher assembly to the snowmobile.

15. The ice scratcher assembly of claim 11, further comprising a hand disposed along the axis and interconnected to the second portion of the base.

16. The ice scratcher assembly of claim 12, further comprising a hand disposed along the axis and interconnected to the second portion of the base.

17. The ice scratcher assembly of claim 13, further comprising a hand disposed along the axis and interconnected to the second portion of the base.

18. The ice scratcher assembly of claim 14, further comprising a hand disposed along the axis and interconnected to the second portion of the base.

19. A method of assembling an ice scratcher to a snowmobile, comprising the steps of:
mounting a base on the rear suspension assembly so that a portion of the base shares an axis with a drive track wheel configured to be coupled to the rear suspension assembly, wherein the base comprises a coil shoulder, an arm interconnected to the coil shoulder, and a scratcher end interconnected to the arm;
mounting a bracket to a side of the base opposite the drive track wheel to secure the ice scratcher to the snowmobile.

20. The method of claim 19, further comprising the step of operating the snowmobile with the ice scratcher assembly mounted thereto.
